(19) United States
(12) Patent Application Publication
(10) Pub. No.: US 2019/0138152 A1
(43) Pub. Date: May 9, 2019

(54) TOUCH PANEL ELECTRODE STRUCTURE FOR USER GROUNDING CORRECTION

(71) Applicant: Apple Inc., Cupertino, CA (US)

(72) Inventors: Marduke YOUSEFPOR, San Jose, CA (US); Shahrooz SHAHPARNIA, Monte Sereno, CA (US)

(21) Appl. No.: 16/201,730

(22) Filed: Nov. 27, 2018

Related U.S. Application Data
(63) Continuation of application No. 15/097,179, filed on Apr. 12, 2016, now abandoned.
Application No. 15/097,179 is a continuation of application No. 14/082,074, filed on Nov. 15, 2013, now abandoned.
Application No. 14/082,074 is a continuation-in-part of application No. 14/082,003, filed on Nov. 15, 2013, now Pat. No. 9,886,141.
(60) Provisional application No. 61/866,849, filed on Aug. 16, 2013.
(60) Provisional application No. 61/866,888, filed on Aug. 16, 2013.

(51) Int. Cl. G06F 3/041; G06F 3/044

(52) U.S. Cl. CPC G06F 3/0418; G06F 3/0416; G06F 2203/04107; G06F 2203/04111; G06F 2203/04101; G06F 3/044

(57) ABSTRACT

A touch panel electrode structure for user grounding correction in a touch panel is disclosed. The electrode structure can include an array of electrodes for sensing a touch at the panel, and multiple jumpers for selectively coupling groups of the electrodes together to form electrode rows and columns that cross each other. In some examples, the array can have a linear configuration and can form the rows and columns by coupling diagonally adjacent electrodes using the jumpers in a zigzag pattern, or the array can have a diamond configuration and can form the rows and columns by coupling linearly adjacent electrodes using the jumpers in a linear pattern. In various examples, each electrode can have a solid structure with a square shape, a reduced area with an outer electrode and a physically separate center electrode, a hollow center, or a solid structure with a hexagonal shape.

### CROSS REFERENCE TO RELATED APPLICATIONS

This application is a continuation of U.S. patent Ser. No. 15/097,197 (now U.S. Publication No. 2016-0224189), filed Apr. 12, 2016, which is a continuation of U.S. patent application Ser. No. 14/082,074 (now U.S. Publication No. 2015-0049044), filed Nov. 15, 2013, which is a Continuation-in-part of U.S. patent application Ser. No. 14/082,003 (now U.S. Pat. No. 9,886,141), filed Nov. 15, 2013, which claims benefit of U.S. Provisional Patent Application No. 61/866,849, filed Aug. 16, 2013 and U.S. Provisional Patent Application No. 61/866,888, filed Aug. 16, 2013, the entire disclosure of which is incorporated herein by reference for all purposes.

### FIELD

This relates generally to touch panel structures and, more specifically, to touch panel electrode structures to correct user grounding.

### BACKGROUND

Many types of input devices are presently available for performing operations in a computing system, such as buttons or keys, mice, trackballs, joysticks, touch panels, touch screens and the like. Touch sensitive devices, and touch screens in particular, are quite popular because of their ease and versatility of operation as well as their affordable prices. A touch sensitive device can include a touch panel, which can be a clear panel with a touch sensitive surface, and a display device such as a liquid crystal display (LCD) that can be positioned partially or fully behind the panel so that the touch sensitive surface can cover at least a portion of the viewable area of the display device. The touch sensitive device can allow a user to perform various functions by touching or hovering over the touch panel using a finger, stylus or other object at a location often dictated by a user interface (UI) being displayed by the display device. In general, the touch sensitive device can recognize a touch or hover event and the position of the event on the touch panel, and the computing system can then interpret the event in accordance with the display appearing at the time of the event, and thereafter can perform one or more actions based on the event.

When the object touching or hovering over the touch panel is poorly grounded, output values indicative of a touch or hover event can be erroneous or otherwise distorted. The possibility of such erroneous or distorted values can further increase when two or more simultaneous events occur at the touch panel. The erroneous or distorted values can be particularly problematic when they impact the panel's ability to distinguish between a touching object and a hovering object.

### SUMMARY

This relates to a touch panel electrode structure for user grounding correction in a touch panel. The electrode structure can include an array of electrodes for sensing a touch at the panel, and multiple jumpers for selectively coupling groups of the electrodes together to form electrode rows and columns that cross each other. In some examples, the array can have a linear configuration and can form the rows and columns by coupling diagonally adjacent electrodes using the jumpers in a zigzag pattern. In alternate examples, the array can have a diamond configuration and can form the rows and columns by coupling linearly adjacent electrodes using the jumpers in a linear pattern. The electrode structure can advantageously correct for poor user grounding conditions and mitigate noise, e.g., AC adapter noise, in the panel, thereby providing more accurate and faster touch signal detection, as well as power savings, and more robustly adapt to various grounding conditions of a user. The electrode structure can further mitigate noise in the panel.

### BRIEF DESCRIPTION OF THE DRAWINGS

FIG. 1 illustrates an exemplary method for correcting for user grounding in touch signals using mutual and self capacitance touch measurements according to various examples.

FIG. 2 illustrates an exemplary user grounding condition in a touch panel with a row-column electrode configuration according to various examples.

FIG. 3 illustrates an exemplary method for correcting for user grounding in touch signals using mutual and self capacitance touch measurements from multiple row-column electrode patterns according to various examples.

FIGS. 4 through 7 illustrate exemplary row-column electrode patterns for measuring mutual and self capacitance touch measurements to correct for user grounding in touch signals according to various examples.

FIG. 8A illustrates another exemplary method for correcting for user grounding in touch signals using mutual and self capacitance touch measurements from multiple row-column electrode patterns according to various examples.

FIG. 8B illustrates still another exemplary method for correcting for user grounding in touch signals using mutual and self capacitance touch measurements from multiple row-column electrode patterns according to various examples.

FIG. 9 illustrates an exemplary row-column electrode structure on which to measure mutual and self capacitances to correct for user grounding in touch signals according to various examples.

FIG. 10 illustrates an exemplary user grounding condition in a touch panel with a pixelated electrode configuration according to various examples.

FIG. 11 illustrates an exemplary method for correcting for user grounding in touch signals using mutual and self capacitance touch measurements from multiple pixelated electrode patterns according to various examples.

FIGS. 12 through 18B illustrate exemplary pixelated electrode patterns for measuring mutual and self capacitance touch measurements to correct for user grounding in touch signals according to various examples.

FIG. 19 illustrates another exemplary method for correcting for user grounding in touch signals using mutual and self capacitance touch measurements from multiple pixelated electrode patterns according to various examples.

FIGS. 20A and 20B illustrate other exemplary pixelated electrode patterns for measuring mutual and self capacitance touch measurements to correct for user grounding in touch signals according to various examples.

FIG. 21 illustrates an exemplary method for correcting for user grounding in touch signals using self capacitance touch measurements from multiple pixelated electrode patterns according to various examples.

FIGS. 22 through 25 illustrate exemplary pixelated electrode patterns for measuring self capacitance touch measurements to correct for user grounding in touch signals according to various examples.

FIG. 26 illustrates an exemplary pixelated electrode structure on which to measure mutual and self capacitances to correct for user grounding in touch signals according to various examples.

FIG. 27 illustrates an exemplary system for correcting for user grounding in touch signals using mutual and self capacitance touch measurements according to various examples.

FIGS. 28 through 30 illustrate exemplary personal devices that can use mutual and self capacitance touch measurements to correct for user grounding in touch signals according to various examples.

FIG. 31 illustrates exemplary touch and water scenarios on a touch panel that can affect touch signals according to various examples.

FIGS. 32 through 37 illustrate additional exemplary row-column electrode structures on which to measure mutual and self capacitances to correct for user grounding in touch signals according to various examples.

### DETAILED DESCRIPTION

In the following description of the disclosure and examples, reference is made to the accompanying drawings in which it is shown by way of illustration specific examples that can be practiced. It is to be understood that other examples can be practiced and structural changes can be made without departing from the scope of the disclosure.

This relates to a touch panel electrode structure for user grounding correction in a touch panel. The electrode structure can include an array of electrodes for sensing a touch at the panel, and multiple jumpers for selectively coupling groups of the electrodes together to form electrode rows and columns, where at least some of the jumpers forming the rows and columns cross each other. In some examples, the array can have a linear configuration and can form the rows and columns by coupling diagonally adjacent electrodes using the jumpers in a zigzag pattern. In some examples, the array can have a diamond configuration and can form the rows and columns by coupling linearly adjacent electrodes using the jumpers in a linear pattern. In some examples, each electrode can have a solid structure with a square shape. In some examples, each electrode can have a reduced area with an outer electrode and a physically separate center electrode. In some examples, each electrode can have a hollow center. In some examples, each electrode can have a solid structure with a hexagonal shape.

The electrode structure can advantageously correct for poor user grounding conditions and/or mitigate noise, e.g., AC adapter noise, in the panel, thereby providing more accurate and faster touch signal detection, as well as power savings, and more robustly adapt to various grounding conditions of a user.

The terms “poorly grounded,” “ungrounded,” “not grounded,” “not well grounded,” “improperly grounded,” “isolated,” and “floating” can be used interchangeably to refer to poor grounding conditions that can exist when a user is not making a low impedance electrical coupling to the ground of the touch panel.

The terms “grounded,” “properly grounded,” and “well grounded” can be used interchangeably to refer to good grounding conditions that can exist when a user is making a low impedance electrical coupling to the ground of the touch panel.

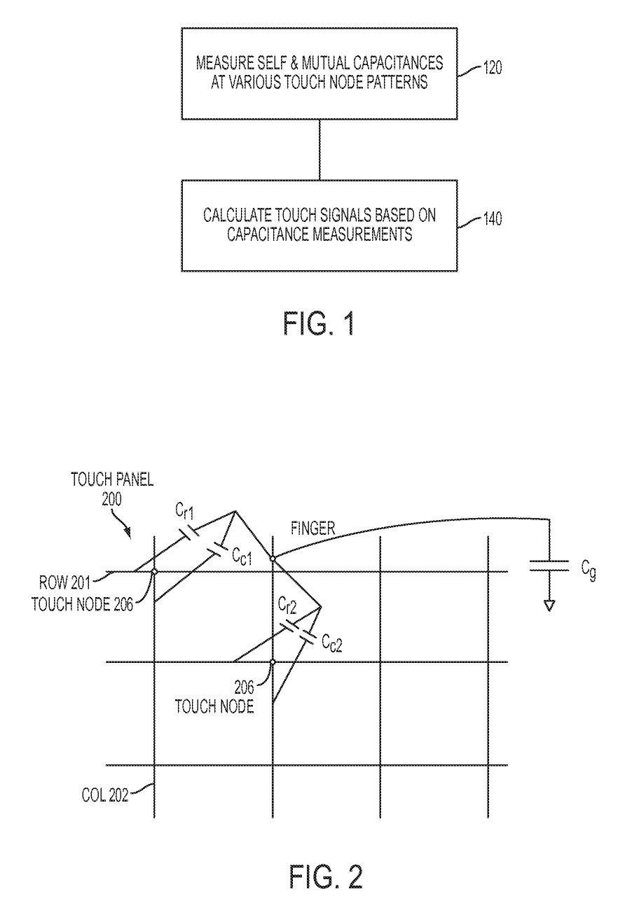

FIG. 1 illustrates an exemplary method for user grounding correction of a touch signal in a touch panel of a touch sensitive device. In the example of FIG. 1, self capacitance and mutual capacitance at various electrode patterns of the panel can be measured to assess the user's grounding condition (120). Based on the self capacitance measurements, the mutual capacitance measurements, or both, a user grounding correction factor can be determined for a touch signal (130). The correction factor can then be used to calculate the touch signal corrected for any poor grounding conditions of the user (140). Several variations of this method will be described in more detail below.

One type of touch panel can have a row-column electrode pattern. FIG. 2 illustrates an exemplary user grounding condition for this type of touch panel. In the example of FIG. 2, touch panel 200 can include an array of touch nodes 206 formed at the crossing points of row conductive traces 201 and column conductive traces 202, although it should be understood that other node configurations can be employed. Each touch node 206 can have an associated mutual capacitance Cm formed between the crossing row traces 201 and column traces 202.

When a well-grounded user's finger (or other object) touches or hovers over the panel 200, the finger can cause the capacitance Cm to reduce by an amount ΔCm at the touch location. This capacitance change ΔCm can be caused by charge or current from a stimulated row trace 201 being shunted through the touching (or hovering) finger to ground rather than being coupled to the crossing column trace 202 at the touch location. Touch signals representative of the capacitance change ΔCm can be transmitted by the column traces 104 to sense circuitry (not shown) for processing. The touch signals can indicate the touch node 206 where the touch occurred and the amount of touch that occurred at that node location.

However, as illustrated in FIG. 2, when a poorly grounded user's finger (or other object) touches or hovers over the panel 200, the finger can form one or more secondary capacitive paths back into the panel rather than to ground. In this example, the finger can be within detectable distance of two touch nodes 206, one node formed by the first row r1 and first column c1 and the other node formed by the second row r2 and second column c2. A finger capacitance Cr1 to the row trace r1, a finger capacitance Cc1 to the column trace c1, and a finger capacitance Cg to user ground can form one secondary path for coupling charge from stimulated row trace r1 back into the panel via column trace c1. Similarly, a finger capacitance Cr2 to the row trace r2, a finger capacitance Cc2 to the column trace c2, and a finger capacitance Cg to user ground can form another secondary path. As a result, instead of the capacitance Cm of the touch node at the touch location being reduced by ΔCm, Cm may only be reduced by (ΔCm−Cneg), where Cneg can represent a so-called “negative capacitance” resulting from the charge coupled into the crossing column trace due to the finger's poor grounding. The touch signals can still generally indicate the touch node 206 where the touch occurred, but with an indication of a lesser amount of touch than actually occurred.

Accordingly, detecting the negative capacitance and correcting the touch signals for the negative capacitance, using a user grounding correction method, can improve touch detection of the touch panel in poor user grounding conditions.

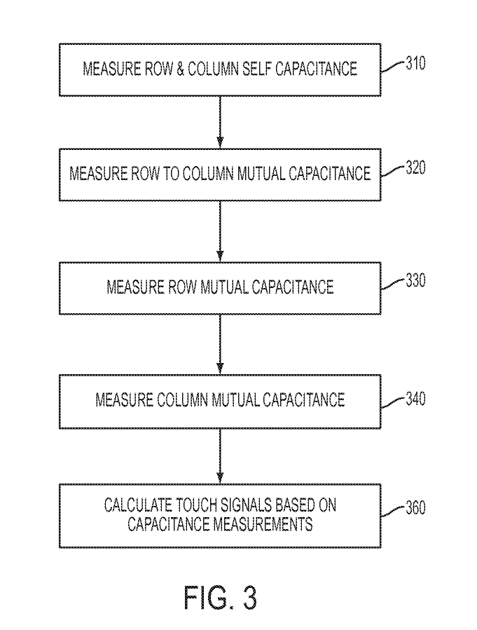

FIG. 3 illustrates an exemplary method for user grounding correction of a touch signal in the row-column touch panel of FIG. 2. In the example of FIG. 3, a touch panel can capture self and mutual capacitances at various row-column electrode patterns in the panel so as to measure the user's grounding condition and calculate a touch signal using the user grounding measurement to correct the touch signal for any poor grounding conditions. Accordingly, the panel can measure self capacitances Xr, Xc of the row and column traces, respectively, in the panel (310). FIG. 5 illustrates an exemplary row-column electrode pattern measuring row and column self capacitances, using a boot strap operation. In the example of FIG. 5, row traces 501 and column traces 502 can be stimulated simultaneously by stimulation signals V provided by drive circuitry (not shown) that can include an alternating current (AC) waveform and can transmit self capacitances Xr, Xc to sense circuitry (not shown) that can include a sense amplifier for the column sense trace 402. Accordingly, the self capacitances Xr, Xc can be measured in a single operation.

In some examples, a touch panel can include a grounding plate underlying the row and column traces and can have gaps between the traces, such that portions of the plate are exposed to a finger proximate (i.e., touching or hovering over) to the traces. A poorly grounded finger and the exposed plate can form a secondary capacitive path that can affect a touch signal. Accordingly, while stimulating the row and column traces, the plate can be stimulated by the stimulation signals V as well so that the row and column self capacitance measurements include the grounding conditions associated with the plate.

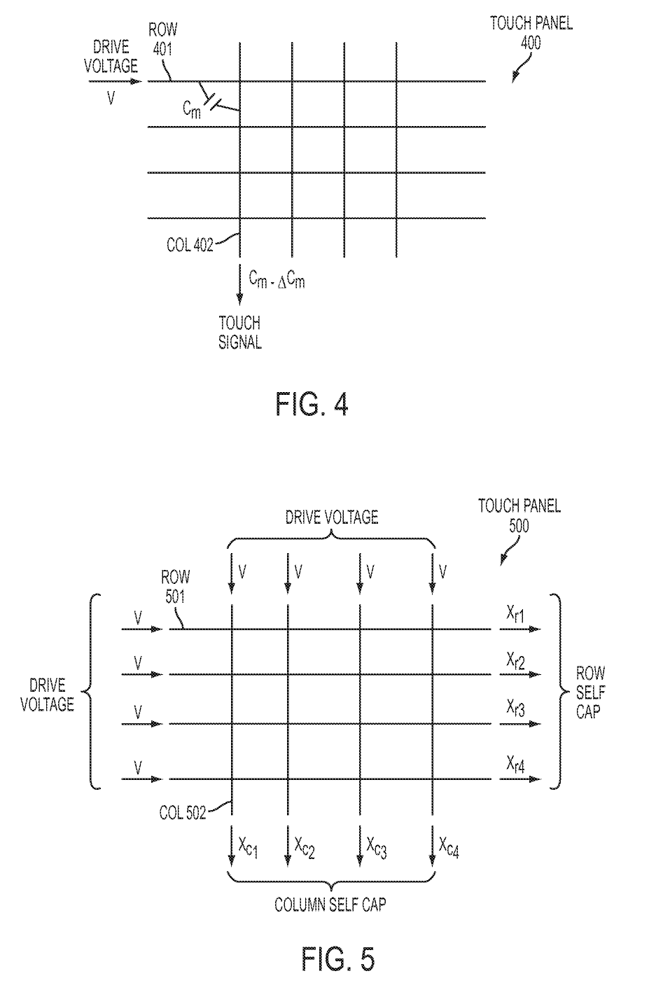

Referring again to FIG. 3, after measuring the self capacitances, the panel can measure row-to-column mutual capacitance Cm (or Yrc) of row and column traces in the panel (320). FIG. 4 illustrates an exemplary row-column electrode pattern measuring row-to-column mutual capacitances. In the example of FIG. 4, touch panel 400 can including row trace 401 functioning as a drive line and column trace 402 functioning as a sense line, where the row and column traces can form mutual capacitance Cm at their crossing. The row drive trace 401 can be stimulated by stimulation signals V provided by drive circuitry (not shown) and the column sense trace 402 can transmit touch signal (Cm−ΔCm), indicative of a touch at the panel 400, to sense circuitry (not shown).

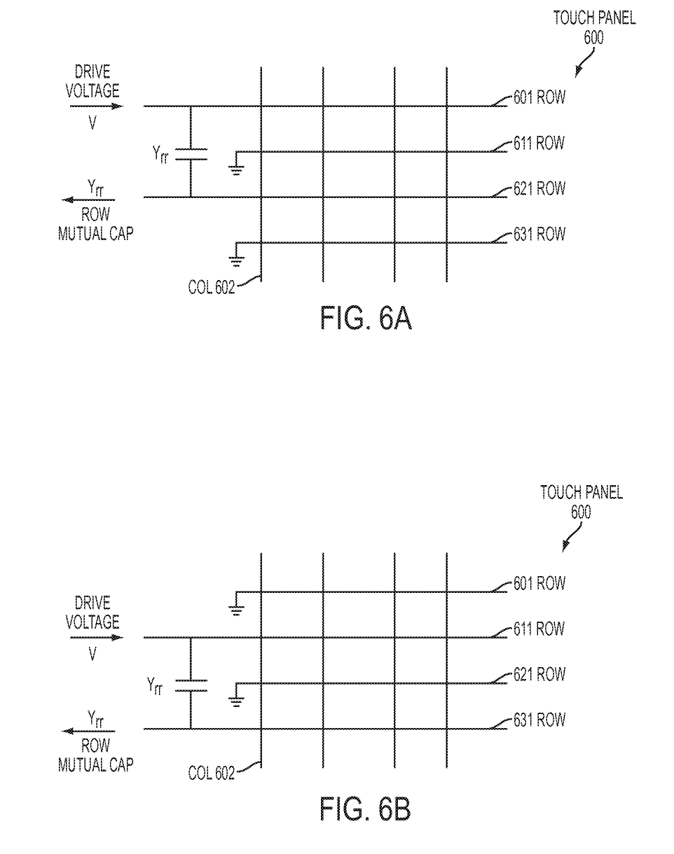

Referring again to FIG. 3, after measuring the row-to column mutual capacitances, the panel can measure row-to-row mutual capacitances Yrr of row traces in the panel (330). FIGS. 6A and 6B illustrate exemplary row-row electrode patterns measuring row-to-row mutual capacitances. In the example of FIG. 6A, touch panel 600 can be configured to form a row-row electrode pattern of the first row 601 as a drive trace, the second row 611 as a ground trace, the third row 621 as a sense trace, the fourth row 631 as another ground trace, and the pattern repeated for the remaining rows. The row drive and sense traces 601, 621 can form mutual capacitance Yrr therebetween. The row drive trace 601 can be stimulated by stimulation signals V provided by drive circuitry (not shown) and the row sense trace 621 can transmit mutual capacitance Yrr to sense circuitry (not shown). To ensure that mutual capacitances are measured for all the rows, the panel 600 can be configured to form another row-row electrode pattern of the first row 601 as a ground trace, the second row 611 as a drive trace, the third row 621 as another ground trace, the fourth row 631 as a sense trace, and the pattern repeated for the remaining rows, as illustrated in FIG. 6B. Like the previous pattern, the row drive trace 611 can be stimulated and the row sense trace 631 can transmit the mutual capacitance Yrr. Accordingly, the mutual capacitances Yrr can be measured in a first operation at one row-row electrode pattern, followed by a second operation at the other row-row electrode pattern. In some examples, the row drive traces can be stimulated one at a time. In some examples, multiple row drive traces can be stimulated at the same time.

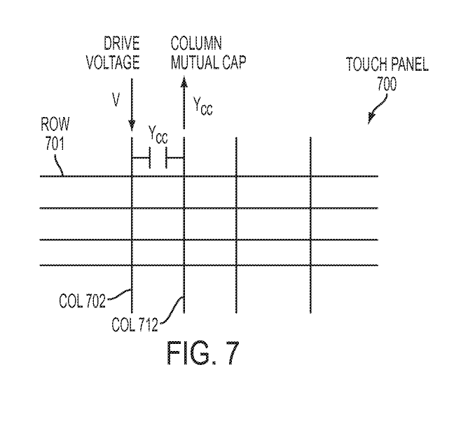

Referring again to FIG. 3, after measuring the row-to-row mutual capacitances, the panel can measure column-to-column mutual capacitances Ycc of column traces in the panel (340). FIG. 7 illustrates an exemplary column-column electrode pattern measuring column-to-column mutual capacitance. In the example of FIG. 7, touch panel 700 can be configured to form a column-column electrode pattern of the first column 702 as a drive trace, the second column 712 as a sense trace, and the pattern repeated for the remaining columns. The column drive and sense traces 702, 712 can form mutual capacitance Ycc therebetween. The column drive trace 702 can be stimulated by stimulation signals V provided by drive circuitry (not shown) and the column sense trace 712 can transmit mutual capacitance Ycc to sense circuitry (not shown). Accordingly, the mutual capacitances Ycc can be measured in one operation at the column-column electrode pattern. In some examples, the column drive traces can be stimulated one at a time. In some examples, multiple column drive traces can be stimulated as the same time.

As illustrated in FIGS. 6A and 6B, a row trace can be configured as a ground trace to separate the row drive and sense traces. This can be done when the traces are very close together so as to avoid strong mutual capacitances between adjacent traces affected by a finger proximate thereto, which can adversely affect the trace-to-trace mutual capacitance measurements. Conversely, as illustrated in FIG. 7, a column ground trace can be omitted. This can be done when the traces are far enough apart so that weaker mutual capacitances between adjacent traces cannot be affected by a finger proximate thereto, so as to not adversely affect the trace-to-trace mutual capacitance measurements. Accordingly, in alternate examples, the row-row electrode pattern can include the first row as a drive trace, the second row as a sense trace, and the pattern repeated for the remaining rows, as illustrated in FIG. 7. Similarly, in alternate examples, one column-column electrode pattern can include the first column as a drive trace, the second column as a ground trace, the third column as a sense trace, the fourth column as another ground trace, and the pattern repeated for the remaining columns, as illustrated in FIG. 6A. Another column-column electrode pattern can include the first column as a ground trace, the second column as a drive trace, the third column as another ground trace, the fourth column as a sense trace, and the pattern repeated for the remaining columns, as illustrated in FIG. 6B. These and other example patterns are possible according to the panel specifications.

Referring again to FIG. 3, after measuring the column-to-column mutual capacitances, a user grounding correction factor can be determined based on the self and mutual capacitance measurements (350) and the correction factor can be used to calculate a touch signal corrected for user poor grounding conditions (360). Equation (1) can be used to calculate the corrected touch signal.

ΔCm_{ij,actual}=ΔCmᵢⱼ+K·XrᵢXcⱼ (1)

where ΔCm_{ij,actual}=the grounding corrected touch signal of the touch node at row trace i and column trace j, ΔCmᵢⱼ=the measured touch signal of the touch node at row trace i and column trace j, Xrᵢ=self capacitance measurement of row trace i, Xc₃=self capacitance measurement of column trace j, and K=f (Xrᵢ, Xcⱼ, Yrᵢrₖ, Ycⱼcₗ), where K is a function of Xrᵢ, Xcⱼ, Yrᵢrₖ (mutual capacitance measurement of row trace i to row trace k), and Ycⱼcₗ (mutual capacitance measurement of column trace j to column trace 1), and indicative of the user's grounding condition. In some examples, K can be determined through empirical analysis of the capacitance measurements.

In alternate examples, K can be determined from an estimate based on negative capacitance measurements, where K=f (ΔCmᵢⱼ<0), such that row-to-row and column-to-column mutual capacitance measurements can be omitted.

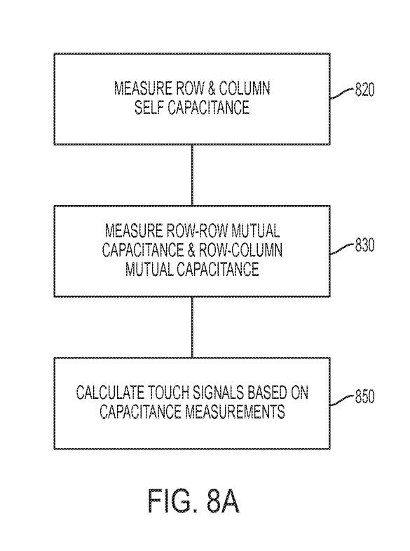

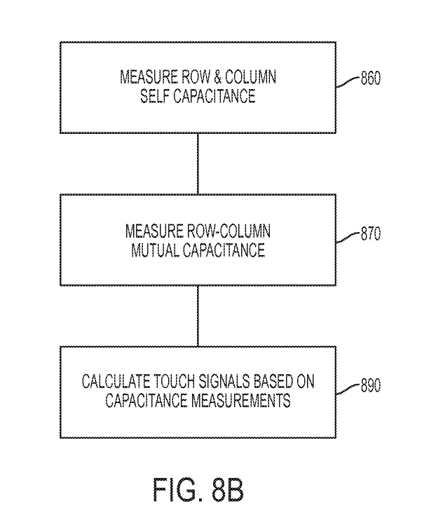

FIG. 8A illustrates another exemplary method for user grounding correction of a touch signal in the row-column touch panel of FIG. 2. The FIG. 8B method is similar to the FIG. 3 method, but can replace the measuring of the column-to-column mutual capacitance with the measuring of row-to-column mutual capacitance and can measure the row-to-column mutual capacitance simultaneously with the row-to-row mutual capacitance. In the example of FIG. 8A, a touch panel can simultaneously measure row and column self capacitance, as illustrated in FIG. 5 (820). The panel can measure row-to-row mutual capacitance, as illustrated in FIGS. 6A and 6B, and additionally measure row-to-column mutual capacitance at the same time, as illustrated in FIG. 4 (830). A user grounding correction factor can be determined based on the self and mutual capacitance measurements (840) such that K=f (Xrᵢ, Xcⱼ, Yrᵢrₖ) and used to calculate a touch signal corrected for user poor grounding conditions (850). In some examples, this method can decrease the measurement time by omitting the separate column-to-column mutual capacitance operation. Reducing measurement time can be desirable in a touch sensitive device that includes a display device along with the touch panel, because the shorter measurement time can occur during the display's blanking (or updating) period, thereby avoiding interference from the display on the measurements.

FIG. 8B illustrates another exemplary method for user grounding correction of a touch signal in the row-column touch panel of FIG. 2. The FIG. 8B method is similar to the FIG. 8A method, but can omit the measuring of the row-to-row mutual capacitance. In the example of FIG. 8B, a touch panel can simultaneously measure row and column self capacitance, as illustrated in FIG. 5 (860). The panel can measure row-to-column mutual capacitance, as illustrated in FIG. 4 (870). A user grounding correction factor can be determined based on the row and col mutual capacitance measurements (880) and used to calculate a touch signal corrected for user poor grounding conditions (890). Here, K=f (ΔCmᵢⱼ<0).

In an alternate method, rather than using the correction factor to calculate a touch signal (890), the mutual capacitance measurement Yricj (mutual capacitance measurement of row trace i to column trace j, or Cmij) can be used to determine the touch signal unless the ΔCmᵢⱼ measurement indicates a negative capacitance. In which case, the self capacitance measurements Xr, Xc can be used to determine the touch signal.

It should be understood that the row-column electrode patterns are not limited to those illustrated in FIGS. 5 through 7, but can include other or additional patterns suitable for measuring self and mutual capacitance of row and column traces in the touch panel. For example the row-column electrode pattern can be configured to include a first row trace as a drive trace, a second row trace as a ground trace, followed by multiple row traces as sense traces to form mutual capacitances with the first row trace, followed by another row trace as another ground trace, and the pattern repeated for the remaining row traces. In an alternate example, the row-column electrode pattern can be configured to include a first row trace as a drive trace, followed by multiple row traces as sense traces to form mutual capacitances with the first row trace, and the pattern repeated for the remaining row traces. Similar patterns can be configured for the column traces.

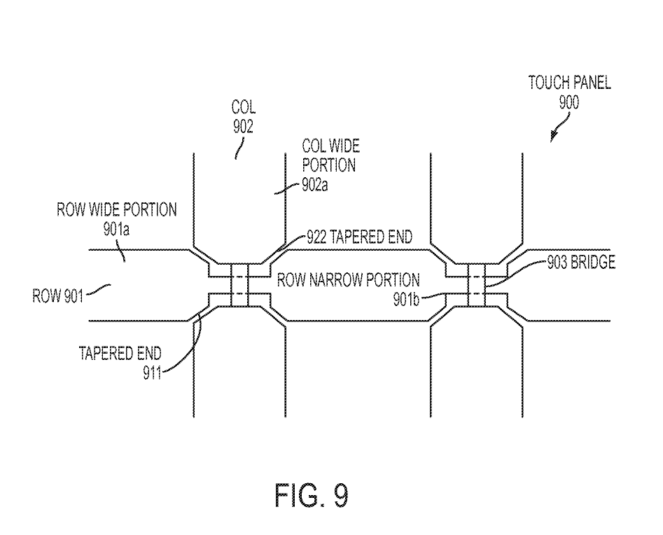

In addition to applying a user grounding correction factor to a touch signal, the structure of the row and column traces can be designed so as to mitigate poor grounding conditions. FIG. 9 illustrates an exemplary row-column electrode structure that can be used. In the example of FIG. 9, touch panel 900 can include row traces 901 and column traces 902. Row trace 901 can form a single trace with alternate wider portions 901a having tapered ends 911 and narrower portions 901b at the tapered ends. Column trace 902 can form separate wider portions 902a having tapered ends 922 that are connected together by conductive bridge 903. The bridge 903 of the column trace 902 can cross the narrower portion 901b of the row trace 901. This structure can advantageously maximize the row-to-column mutual capacitance forming touch signals, while minimizing trace area that can be affected by noise introduced by the stimulation signals V, row-to-row and/or column-to-column mutual capacitance that can negatively affect touch signals, and row and column to ground capacitance that can negatively affect touch signals.

In alternate examples, the row traces 901 can have separate wider portions and conductive bridges that connect together the wider portions, like the column traces 902. In other alternate examples, the column traces 902 can form single traces with alternate wider and narrower portions.

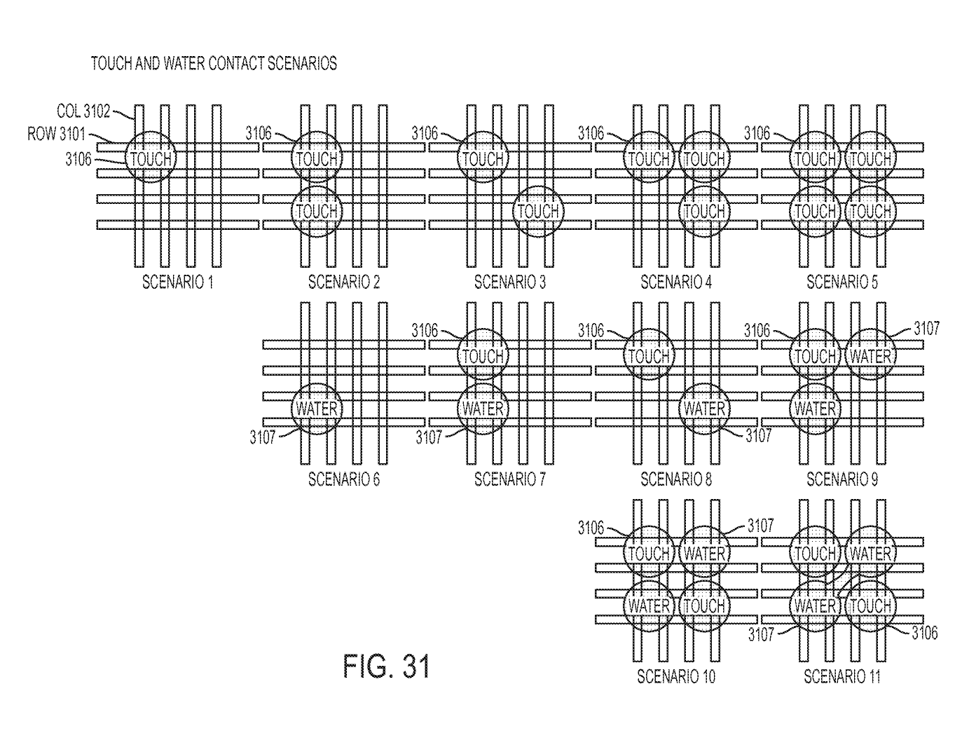

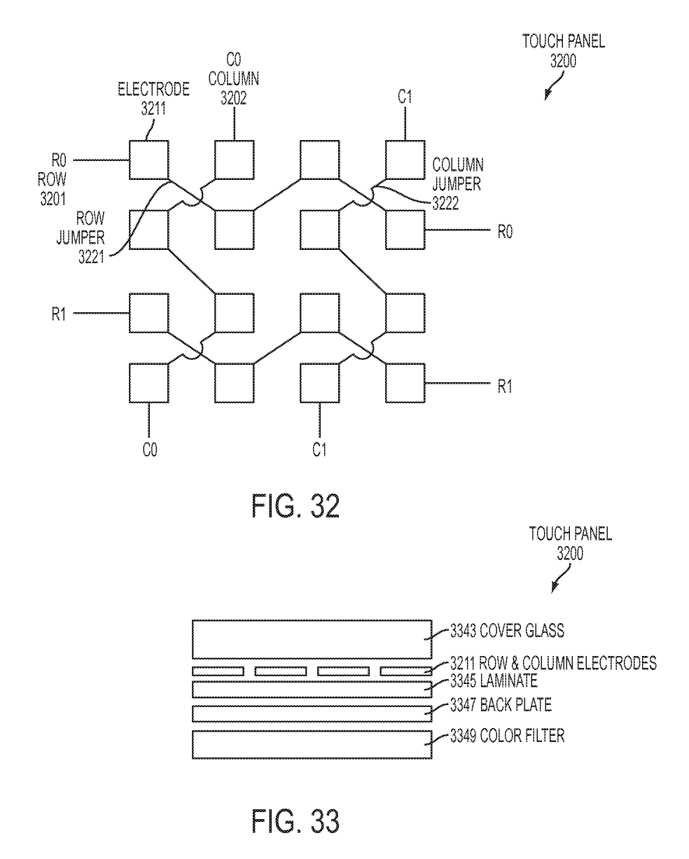

FIGS. 32 through 37 illustrate additional exemplary row-column electrode structures that can be used. As described previously, these structures can advantageously minimize the electrode area that can be affected by noise introduced into the panel and row-to-row and/or column-to-column mutual capacitance that can negatively affect touch signals. Additionally, these structures can minimize the size of touch needed to correct for user grounding. For example, by minimizing the row-to-row and column-to-column mutual capacitances in these structures, adjacent rows and columns need not be spaced farther apart or have a ground electrode or trace therebetween. As such, a user's finger (through which the mutual capacitances can be measured) can touch a smaller area of the panel so as to encompass requisite electrode rows and columns. In some examples, the touch size can be a 2×2 electrode row-column area. In some examples, the touch size can be a 3×3 electrode row-column area.

In the example of FIG. 32, touch panel 3200 can include multiple electrodes 3211, where some of the electrodes can be coupled to conductive jumpers (or bridges) 3221 to form electrode rows 3201 and conductive jumpers (or bridges) 3222 to form electrode columns 3202. Here, the rows 3201 can be substantially horizontal in a zigzag pattern and the columns 3012 substantially vertical in another zigzag pattern. Some of the jumpers 3221, 3222 can cross to form mutual capacitances between their respective rows 3201 and columns 3202. Here, a row zigzag pattern can refer to a first electrode 3211 in a first array row and column, coupled to a second electrode in a second array row and column, coupled to a third electrode in the first array row and third array column, coupled to a fourth electrode in the second array row and fourth array column, and so on, where the zigzag can be between the first and second array rows. Similarly, a column zigzag pattern can refer to a first electrode 3211 in a first array row and second array column, coupled to a second electrode in a second array row and first array column, coupled to a third electrode in a third array row and the second array column, coupled to a fourth electrode in a fourth array row and the first array column, and so on, where the zigzag can be between the first and second array columns.

FIG. 33 illustrates a partial stack-up of the structure of FIG. 32. In the example of FIG. 32, touch panel 3200 can include cover glass 3343 having a touchable surface that a user can touch or hover over and an under surface proximate to the row-column electrode structure of FIG. 32. In some examples, the cover glass 3343 can be glass, plastic, polymer, or any suitable transparent material. In some examples, the row-electrode structure can be indium-tin-oxide (ITO) or any suitable transparent, conductive material. The touch panel 3200 can also include laminate 3345 on the row-column electrode structure to cover and protect the structure. The laminate can be any suitable protective material. The touch panel 3200 can further include back plate 3347 proximate to the laminate 3345 to act as a shield and color filter 3349 proximate to the back plate to provide color information. In some examples, the back plate can be ITO.

This stack-up can similarly be used for any of the other electrodes structures described herein, e.g., FIGS. 9, 26, and 34-37, with their electrode structures replacing the FIG. 32 structure in the stack-up.

Touch panel electrode structures can be subject to noise from other elements either internal or external to the panel. One particular element that can introduce noise into the structures can be a power adapter, e.g., an AC adapter, connected to the panel to provide power. The adapter noise can couple to the electrodes and negatively affect the mutual capacitance therein. To reduce this adapter noise, the electrode areas can be reduced so as to reduce the amount of noise coupling.

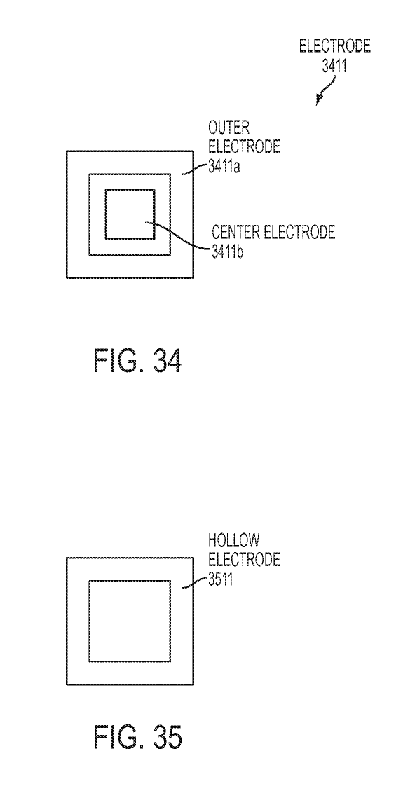

FIG. 34 illustrates a row-column electrode with a reduced electrode area so as to reduce adapter noise. In the example of FIG. 34, electrode 3411 can have outer electrode 3411a and center electrode 3411b, in which the center electrode can float so as to reduce noise coupling and row-to-row and/or column-to-column mutual capacitances. In some examples, the back plate (as illustrated in FIG. 33, element 3347) proximate to the center electrode 3411b can be stimulated by stimulation voltage V concurrently with a row electrode (as illustrated in FIG. 32, element 3201) so as to minimize the row and column to ground capacitance that can negatively affect touch signals. The electrode 3411 in FIG. 34 can replace the electrode 3211 in FIG. 32, so as to form electrode rows 3201 and columns 3202 using the electrodes 3411.

FIG. 35 illustrates a row-column electrode with a hollow electrode area so as to reduce adapter noise. FIG. 35 is similar to FIG. 34 with the center electrode removed. In the example of FIG. 35, electrode 3511 can have its center hollowed out. The electrode 3511 in FIG. 35 can replace the electrode 3211 in FIG. 32, so as to form electrode rows 3201 and columns 3202 using the electrodes 3511.

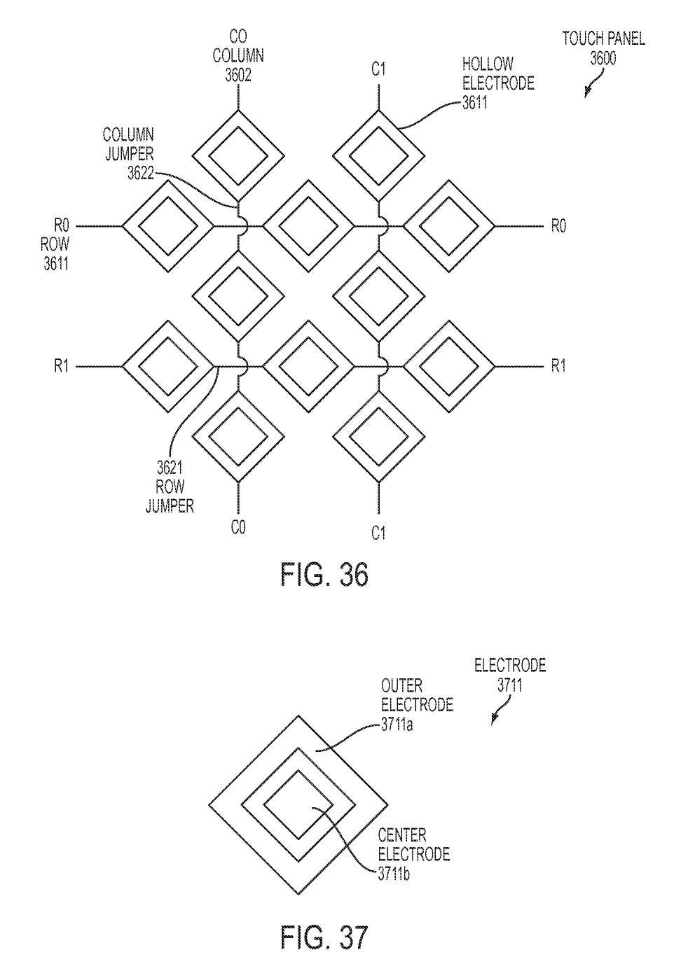

FIG. 36 illustrates a row-column electrode structure having a diamond configuration and hollow electrode areas so as to reduce adapter noise. FIG. 36 is similar to FIG. 34 with a diamond configuration rather than a square configuration. In the example of FIG. 36, touch panel 3600 can include multiple electrodes 3611, where some of the electrodes can be coupled to conductive jumpers (or bridges) 3621 to form electrode rows 3601 and conductive jumpers (or bridges) 3122 to form electrode columns 3602. Here, the rows 3601 can be horizontal and the columns 3602 can be vertical. The jumpers 3621, 3622 can cross to form mutual capacitances between the rows 3601 and columns 3602. The electrodes 3611 can be hollow in their centers.

FIG. 37 illustrates a row-column electrode with a reduced electrode area so as to reduce adapter noise. FIG. 37 is similar to FIG. 34 with a diamond configuration rather than a square configuration. In the example of FIG. 37, electrode 3711 can have outer electrode 3711a and center electrode 3711b, where the center electrode can float. The electrode 3711 of FIG. 37 can replace the electrode 3611 of FIG. 36, so as to form electrode rows 3601 and columns 3602 with the electrodes 3711.

In alternate examples, the electrodes in the diamond configuration can have solid electrode areas with tapered corners like the row and column traces of FIG. 9 to form hexagonal shapes and with jumpers (or bridges) connecting some of the electrodes in horizontal rows and others of the electrodes in vertical columns. The jumpers can cross to form mutual capacitances between the rows and columns.

The row-column electrode structures of FIGS. 32 through 37 can be used to perform the methods of FIGS. 3 and 8 to correct user grounding.

Water can be introduced into a row-column touch panel in a variety of ways, e.g., humidity, perspiration, or a wet touching object, and can cause problems for the panel because the water can couple with any row or column in the panel to form a mutual capacitance, making it difficult to distinguish between the water and a touch or hover event. Moreover, the water can create a negative capacitance in the panel, particularly, when it shares row and/or column traces with the touch or hover event.

FIG. 31 illustrates exemplary water and touch scenarios that a row-column touch panel can encounter which can cause the difficulties described above. In the example of FIG. 31, scenario 1 illustrates a single touch 3106 without water at the row traces 3101 and column traces 3102 of the panel. Scenarios 2 through 5 illustrate multiple touches 3106 without water at various locations on the panel. Scenario 6 illustrates a water droplet 3107 without a touch on the panel. Scenarios 7 through 11 illustrate one or more water droplet 3107 and one or more touch 3106 at various locations on the panel at the same time, where the water and the touch share row and/or column traces. Scenario 11 illustrates the water droplets 3107 converging to create a larger water blob on the panel. It should be understood that these scenarios are for exemplary purposes only, as other scenarios are also possible.

The methods of FIGS. 3, 8A and 8B, the patterns of FIGS. 5 through 7, and the structure of FIG. 9 can be used to correct a touch signal for water effects. In the example of FIG. 3, after the self and mutual capacitance measurements are captured (310-340), the user grounding correction factor can be calculated (350). The correction factor can then be used to calculate a touch signal corrected for any poor user grounding condition and for water effects (360). As described previously, the user grounding correction factor K can be a function of the row self capacitance measurement Xr, the column self capacitance measurement Xc, the mutual capacitance measurement between row traces Yrr, and the mutual capacitance measurement between column traces Ycc. Water can generally contribute to the mutual capacitance measurements, causing the correction factor K to be larger than it should be. As a result, the correction factor K can overcorrect in the touch signal calculations to generate overcompensated false touches at the water contact locations on the panel, particularly when a touch or hover event and a water droplet share the same row and/or column traces. Once the touch signal is corrected, the water locations can be identified based on the fact that the water touch signal will still remain negative. In some examples, the touch signals calculated at the identified water locations can be discarded. In some examples, the touch signal calculations can be skipped at the identified water locations.

In an alternate example, when the row-to-column mutual capacitances are measured (320), the water locations can be identified from these measurements, as described previously. The row-to-row and column-to-column mutual capacitances Yrr, Ycc can then be selectively measured at the non-water locations (330-340) so that the correction factor K is not overestimated.

In the example of FIG. 8B, rather than using the user grounding correction factor to calculate a touch signal (890), the mutual capacitance measurement Yrc, measured in (870), can be used to determine the touch signal unless the Yrc measurement indicates the presence of water, e.g., a negative capacitance. In which case, the self capacitance measurements Xr, Xc, measured in (860), can be used to determine the touch signal.

Various user grounding conditions and water effects can be corrected in touch signals at a touch panel according to various examples described herein. In one example, when a poorly grounded user's ten fingers and two palms are touching in close proximity on the panel, negative capacitance can affect some or all of the touch signals, e.g., the ring and index finger touch signals can be substantially impacted by negative capacitance. Applying the correction methods described herein, the negative capacitance effects can be corrected and the correct touch signals recovered at the correct locations on the panel.

In a second example, water patches can be added to the touch conditions in the first example, e.g., with the water patches disposed between the thumbs and the palms, causing negative capacitance from both the fingers' proximity and the water. Applying the correction methods described herein, the negative capacitance effects can be corrected in the touch signals to recover the actual touch signals at the correct locations on the panel and to minimize the false touches caused by the water.

In a third example, when water patches are large compared to fingers touching on the panel, the water substantially contribute to the negative capacitance so as to overwhelm the touch signals. Applying the correction methods described herein, the water locations can either be skipped or the calculated touch signals involving the water locations discarded so that the actual touch signals can be recovered at the correct locations on the panel without any false touches caused by water.

In a fourth example, two users can be touching the panel, where one user is well grounded and the other user is poorly grounded. In some cases, the well-grounded user can effectively ground the poorly grounded user such that the poorly grounded user's effect on the touch signals is lower. Accordingly, applying the correction methods described herein, lesser correction can be made to the touch signals, compared to the poorly grounded user alone touching the panel.

In a fifth example, display noise can be introduced into the touch conditions of the first example, causing touch signal interference in addition to the negative capacitance due to poor grounding. Applying the correction methods described herein, the negative capacitance effects can be corrected and the noise minimized such that the correct touch signals are recovered at the correct locations on the panel.

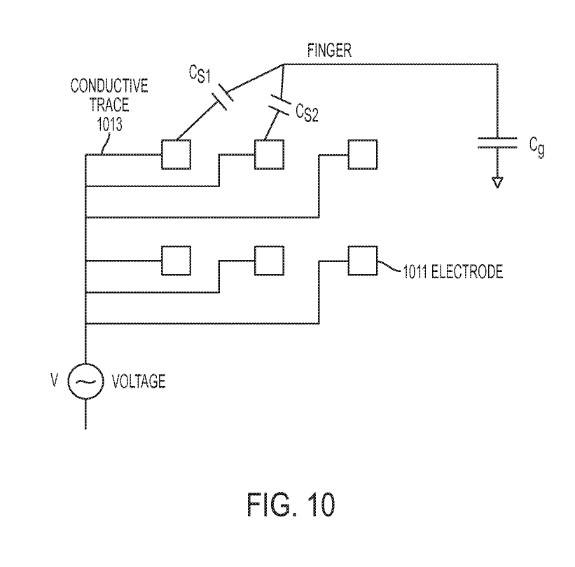

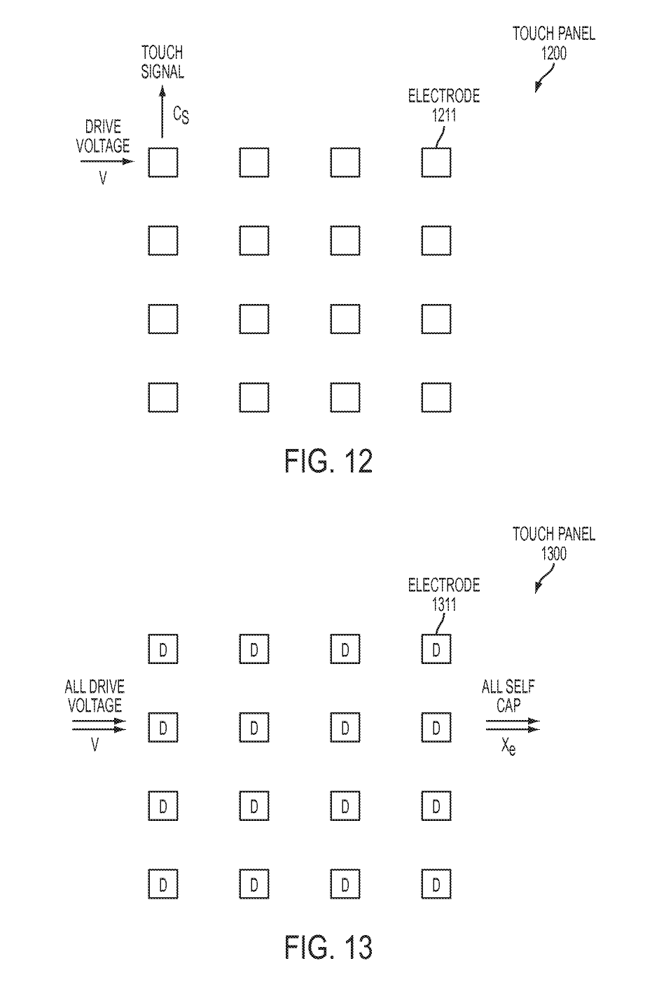

Another type of touch panel can have a pixelated electrode pattern. FIG. 10 illustrates an exemplary user grounding condition for this type of panel. In the example of FIG. 10, touch panel 1000 can include an array of individual touch electrodes 1011, although it should be understood that other electrode configurations can be employed. Each electrode 1011 can have conductive trace 1013 coupled thereto to drive the electrode with drive voltage V and a sensor trace (not shown) to transmit touch signals to sensing circuitry. Each electrode 1011 can have an associated self capacitance relative to ground and can form self capacitance Cs with a proximate finger (or other object). FIG. 12 illustrates an exemplary pixelated touch panel capturing a touch signal. In the example of FIG. 12, touch panel 1200 can include touch electrode 1211, which can be driven by drive voltage V provided by drive circuitry (not shown) to form capacitance Cs with a finger, indicative of a touch at the panel 1200. The touch signal Cs can be transmitted to sense circuitry (not shown).

Referring again to FIG. 10, when a well-grounded user's finger (or other object) touches or hovers over the panel 1000, the finger can form a self capacitance Cs with the electrode 1011 at the touch location. This capacitance can be caused by charge or current from driven conductive trace 1013 to the electrode 1011. In some examples, the electrodes 1011 can be coupled to and driven by the same voltage source. In other examples, the electrodes 1011 can each be coupled to and driven by different voltage sources. Touch signals representative of the capacitance Cs can be transmitted by sensor traces to sense circuitry (not shown) for processing. The touch signals can indicate the electrode 1011 where the touch occurred and the amount of touch that occurred at that electrode location.

However, as illustrated in FIG. 10, when a poorly grounded user's finger (or other object) touches or hovers over the panel 100, the capacitance Cg can be poor such that the capacitance Cs formed between the electrode 1011 and the user's finger is different from what it should be. In this example, the finger can be within detectable distance of two electrodes 1011. A finger capacitance Cs1 to the first electrode and a finger capacitance Cs2 to the second electrode can form. However, because user to ground capacitance Cg is poor, the finger capacitance Cs1, Cs2 can be incorrect. Based on the incorrect capacitance Cs1, Cs2, the panel 1000 can fail to differentiate between a touching, but poorly grounded finger and a hovering, but well-grounded finger.

Accordingly, detecting the poor grounding and correcting the touch signals for the poor grounding, using a user grounding correction method, can improve touch detection of the touch panel in poor user grounding conditions.

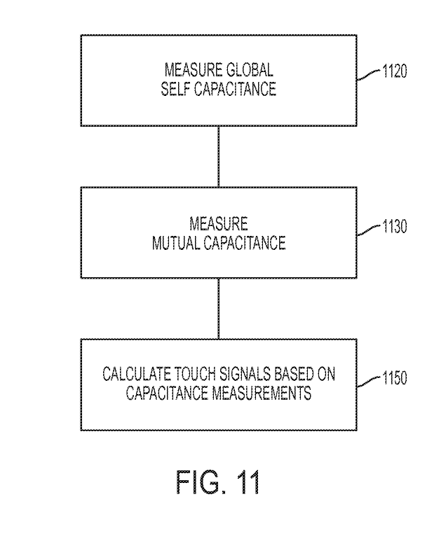

FIG. 11 illustrates an exemplary method for user grounding correction of a touch signal in the pixelated touch panel of FIG. 10. In the example of FIG. 11, a touch panel can capture self and mutual capacitances at various pixelated electrode patterns in the panel so as to measure the user's grounding condition and calculate a touch signal using the user grounding measurement to correct the touch signal for any poor grounding conditions. Accordingly, the panel can measure global self capacitances Xe of the electrodes in the panel (1120). FIG. 13 illustrates an exemplary pixelated touch panel measuring global self capacitances, using a boot strap operation. In the example of FIG. 13, electrodes 1311 can be driven simultaneously by drive voltage V provided by drive circuitry (not shown) and can transmit self capacitances Xe to sense circuitry (not shown). The label “D” on each electrode 1311 can indicate that the electrode is being driven. Accordingly, the self capacitances Xe can be measured in a single operation.

Referring again to FIG. 11, after measuring the global self capacitances, the panel can measure mutual capacitances Yee between diagonal electrodes in the panel (1130). FIGS. 14 through 17 illustrate exemplary pixelated electrode patterns measuring electrode mutual capacitances. In the example of FIG. 14, touch panel 1400 can be configured to form a pixelated electrode pattern with electrode 1411a as a drive electrode, horizontally adjacent electrode 1411b as a ground electrode, vertically adjacent electrode 1411c as another ground electrode, diagonal electrode 1411d as a sense electrode, and the pattern repeated for the remaining electrodes. The label “D” on certain electrodes 1411 can indicate the electrode is being driven, the label “G,” the electrode being grounded, and the label “S,” the electrode sensing mutual capacitance. The drive electrode 1411a and the sense electrode 1411d can form mutual capacitance Yee therebetween. The drive electrode 1411a can be driven by drive voltage V provided by drive circuitry (not shown) and the sense electrode 1411d can transmit mutual capacitance Yee to sense circuitry (not shown).

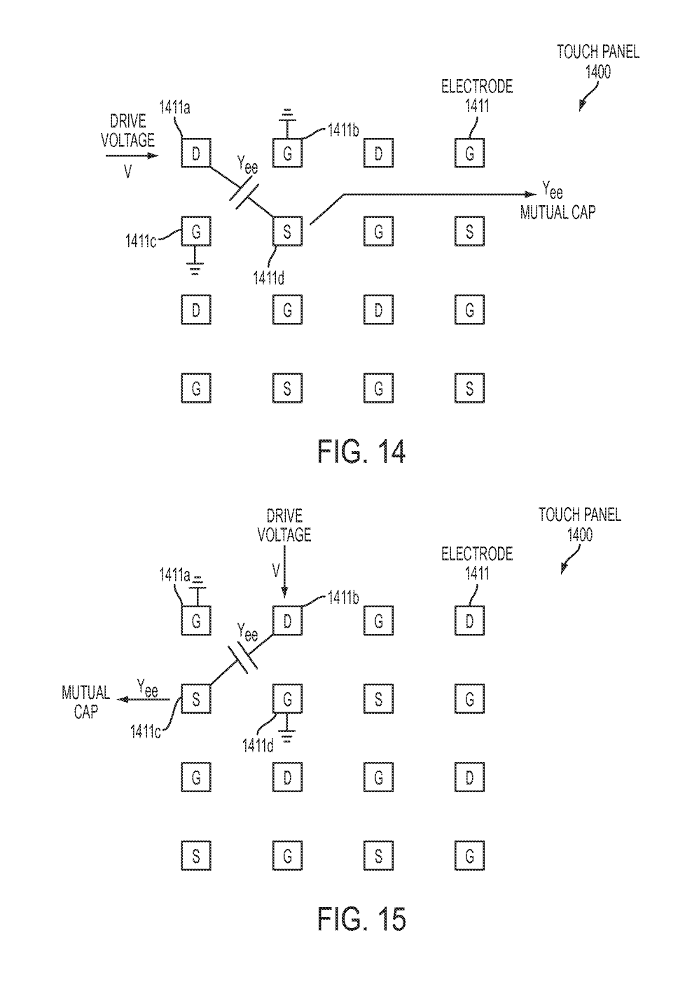

To ensure that mutual capacitances are measured for all the electrodes, the panel can be configured to form a second pixelated electrode pattern by rotating the pattern of FIG. 14 clockwise 45 degrees. FIG. 15 illustrates the second pixelated electrode pattern. In the example of FIG. 15, touch panel 1400 can be configured to form a pixelated electrode pattern with electrode 1411a now as a ground electrode, electrode 1411b as a drive electrode, electrode 1411c as a sense electrode, electrode 1411d as another ground electrode, and the pattern repeated for the remaining electrodes. The drive electrode 1411b and the sense electrode 1411c can form mutual capacitance Yee therebetween.

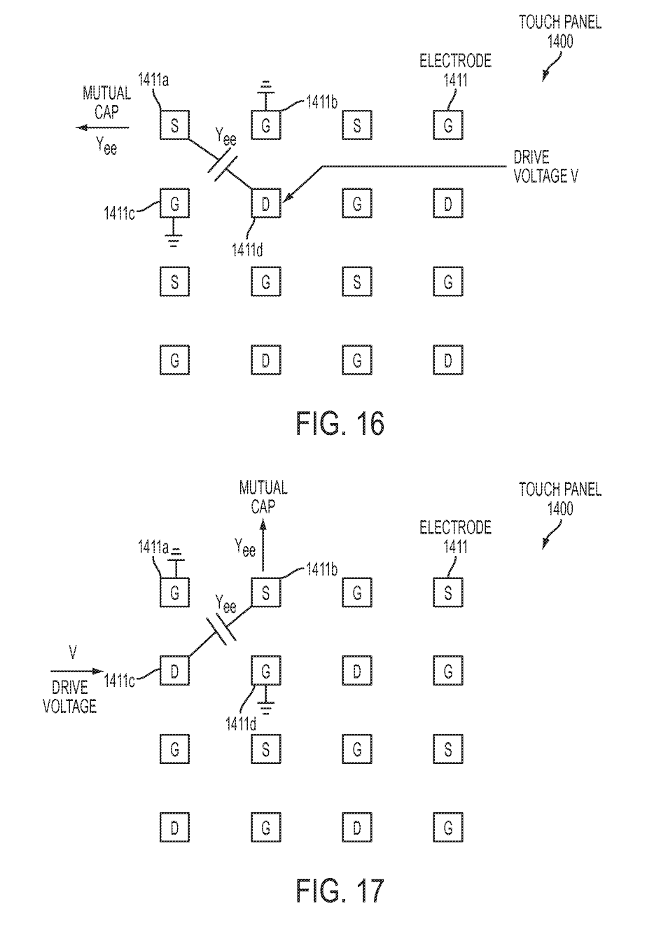

Generally, the patterns of FIGS. 14 and 15 can be sufficient to measure mutual capacitances between electrodes. However, two more patterns as illustrated in FIGS. 16 and 17 can be used for additional measurements to average with the measurements obtained from the patterns of FIGS. 14 and 15. FIG. 16 illustrates a third pixelated electrode pattern formed by rotating the pattern of FIG. 15 clockwise 45 degrees. In the example of FIG. 16, touch panel 1400 can be configured to form a pixelated electrode pattern with electrode 1411a now as a sense electrode, electrode 1411b as a ground electrode, electrode 1411c as another ground electrode, electrode 1411d as a drive electrode, and the pattern repeated for the remaining electrodes. The drive electrode 1411d and the sense electrode 1411a can form mutual capacitance Yee therebetween.

FIG. 17 illustrates a fourth pixelated electrode pattern formed by rotating the pattern of FIG. 16 clockwise 45 degrees. In the example of FIG. 17, touch panel 1400 can be configured to form a pixelated electrode pattern with electrode 1411a now as a ground electrode, electrode 1411b as a sense electrode, electrode 1411c as a drive electrode, electrode 1411d as another ground electrode, and the pattern repeated for the remaining electrodes. The drive electrode 1411c and the sense electrode 1411b can form mutual capacitance Yee therebetween. Accordingly, the mutual capacitances Yee can be measured in either two operations (FIGS. 14 and 15 patterns) or four operations (FIGS. 14 through 17 patterns).

As described previously, when all four patterns are used, the mutual capacitances can be averaged. For example, the mutual capacitances between electrodes 1411a, 1411d, measured using the patterns of FIGS. 14 and 16, can be averaged to provide the mutual capacitance Yee between these two electrodes. Similarly, the mutual capacitances between electrodes 1411b, 1411c, measured using the patterns of FIGS. 15 and 17, can be averaged to provide the mutual capacitance Yee between these two electrodes. The same can be done for the remaining electrodes in the panel.

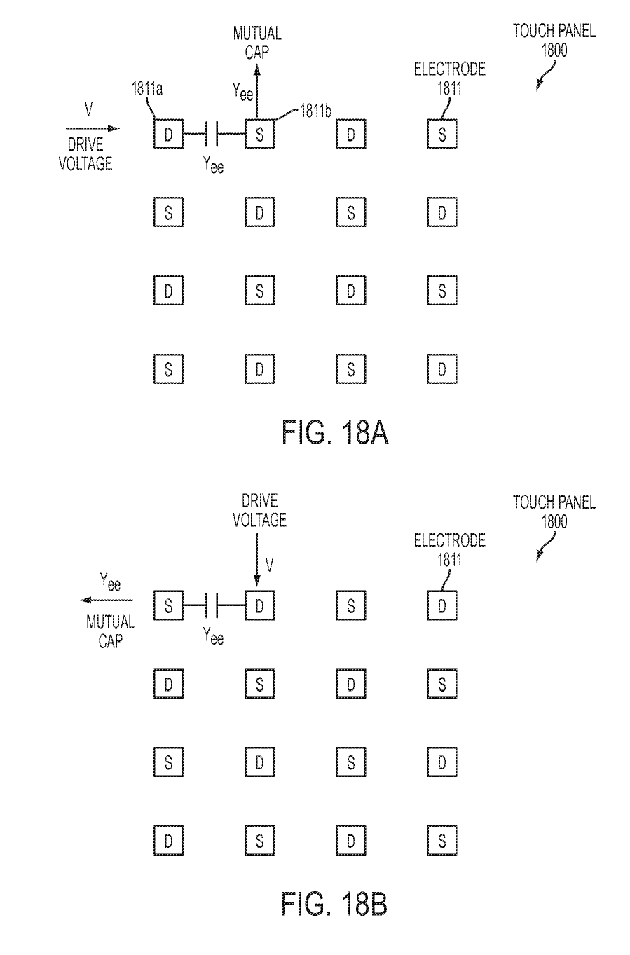

FIGS. 18A and 18B illustrate alternate pixelated electrode patterns measuring electrode mutual capacitances that can replace the patterns of FIGS. 14 through 17. In the example of FIG. 18A, touch panel 1800 can be configured to form a pixelated electrode pattern with electrode 1811a as a drive electrode, horizontally adjacent electrode 1811b as a sense electrode, and the pattern repeated for the remaining electrodes. The label “D” on certain electrodes 1811 can indicate the electrode is being driven and the label “S,” the electrode sensing mutual capacitance. Unlike the patterns of FIGS. 14 through 17, the patterns of FIG. 18A can omit grounding certain electrodes. The drive electrode 1811a and the sense electrode 1811b can form mutual capacitance Yee therebetween. The drive electrode 1811a can be driven by drive voltage V provided by drive circuitry (not shown) and the sense electrode 1811b can transmit mutual capacitance Yee to sense circuitry (not shown).

Generally, the pattern of FIG. 18A can be sufficient to measure mutual capacitances between electrodes. However, a second pattern as illustrated in FIG. 18B can be used for additional measurements to average with the measurements obtained from the pattern of FIG. 18A. In the example of FIG. 18B, touch panel 1800 can be configured to form a pixelated electrode pattern with electrode 1811a now as a sense electrode, electrode 1811b as a drive electrode, and the pattern repeated for the remaining electrodes. The drive electrode 1811b and the sense electrode 1811a can form mutual capacitance Yee therebetween. Accordingly, the mutual capacitances Yee can be measured in either one operation (FIG. 18A pattern) or two operations (FIGS. 18A and 18B patterns). The mutual capacitances between electrodes 1811a, 1811b measured using the two patterns of FIGS. 18A and 18B can be averaged to provide the mutual capacitance Yee between the two electrodes. The same can be done for the remaining electrodes in the panel.

It should be understood that the pixelated electrode patterns are not limited to those illustrated in FIGS. 14 through 18B, but can include other or additional patterns suitable for measuring self and mutual capacitance of electrodes in the touch panel. For example, a pixelated electrode pattern can be configured to include a first row of electrodes being drive electrodes, a second row of electrodes being ground electrodes, a third row of electrodes being sense electrodes to form mutual capacitances with the first row electrodes, a fourth row of electrodes being ground electrodes, and the pattern repeated for the remaining electrode rows. In another example, a pixelated electrode pattern can be configured to include a first electrode being a drive electrode, adjacent electrodes surrounding the first electrode being ground electrodes, adjacent electrodes surrounding the ground electrodes being sense electrodes to form mutual capacitances with the first electrode, and the pattern repeated for the remaining electrodes.

Referring again to FIG. 11, after measuring the mutual capacitances, a user grounding correction factor can be determined based on the self and mutual capacitance measurements (1140) and the correction factor can be used to calculate a touch signal corrected for user poor grounding conditions (1150). Equation (2) can be used to calculate the corrected touch signal.

$${Cm}_{i} = [ \frac{Cg}{{\sum }_{i} {Cm}_{i , actual} + Cg} ] {Cm}_{i , actual} \qquad ( 2 )$$

where Cmᵢ=the captured touch signal at touch electrode i, Cm_{i,actual}=the grounding corrected touch signal at electrode i, and Cg=f (Xeᵢ, Yeᵢeⱼ), user ground capacitance, where Cg is a function of Xeᵢ (self capacitance measurement of touch electrode i when all touch electrode are simultaneously driven, boot-strapped) and Yeᵢeⱼ (mutual capacitance measurement of touch electrode i to touch electrode j), and indicative of the user's grounding condition. An alternate way of computing the correction factor form can be K=Cg/[sum(Cm_{i,actual})+Cg]=K(Xeᵢ, Yeᵢeⱼ) which leads to a simple global scalar correction factor form of Cm₁=K Cm_{i,actual}.

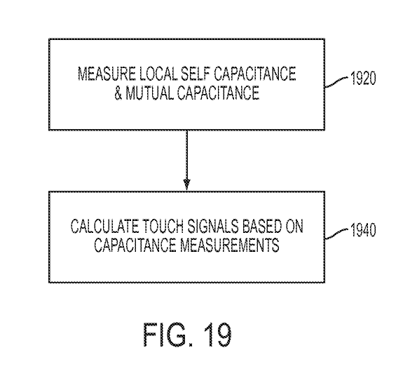

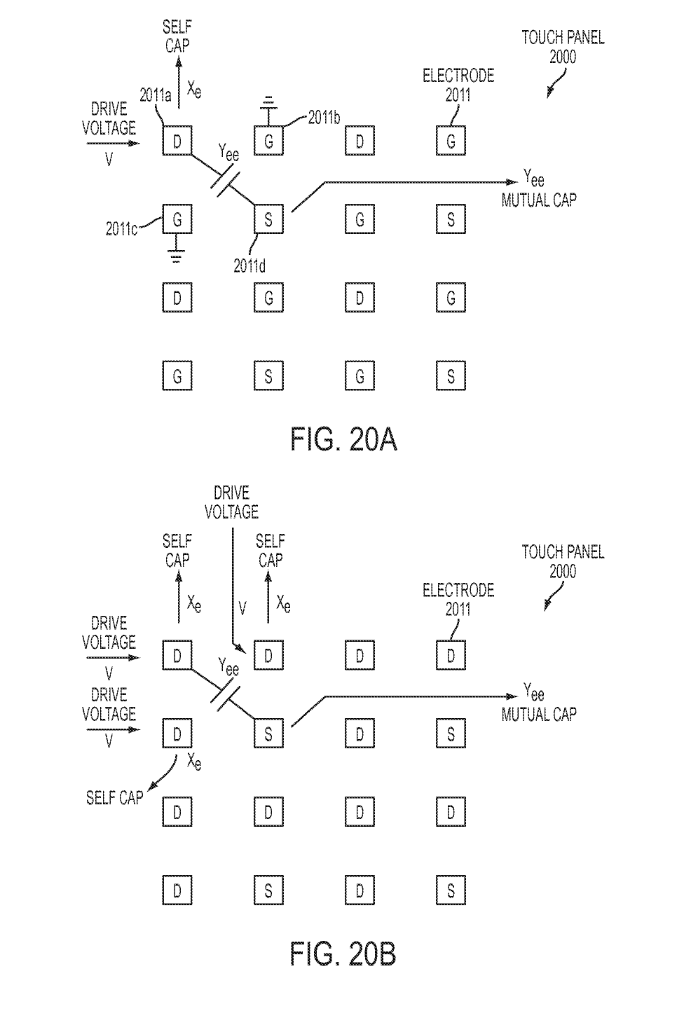

FIG. 19 illustrates another exemplary method for user grounding correction of a touch signal in the pixelated electrode touch panel of FIG. 10. The FIG. 19 method is similar to the FIG. 11 method, but can replace the measuring of global self capacitance with the measuring of local self capacitance and can measure the local and mutual self capacitances simultaneously. In the example of FIG. 19, a touch panel can measure the mutual capacitance Yee between the electrodes and additionally measure local self capacitance Xe at the same time, using a non-boot strap operation (1920). FIG. 20A illustrates an exemplary pixelated electrode pattern measuring self and mutual capacitance. In the example of FIG. 20A, similar to FIG. 14, touch panel 2000 can be configured to form a pixelated electrode pattern with electrode 2011a as a drive electrode, horizontally adjacent electrode 2011b as a ground electrode, vertically adjacent electrode 2011c as another ground electrode, diagonal electrode 2011d as a sense electrode, and the pattern repeated for the remaining electrodes. To measure the local self capacitance, while electrode 2011a is being driven to provide the mutual capacitance Yee between it and sense electrode 2011d, the self capacitance Xe of drive electrode 2011a can be measured. Additional pixelated electrode patterns similar to those of FIGS. 15 through 17 can be formed, in which drive electrode 1411b has its self capacitance measured (FIG. 15), drive electrode 1411c has its self capacitance measured (FIG. 16), and drive electrode 1411d has its self capacitance measured (FIG. 17), for example.

Referring again to FIG. 19, after measuring the self and mutual capacitances, a user grounding correction factor can be determined based on the self and mutual capacitance measurements (1930) and used to calculate a touch signal corrected for user poor grounding conditions (1940). As described previously, Equation (2) can be used to perform the correction.

It should be understood that the pixelated electrode patterns are not limited to that illustrated in FIG. 20A, but can include other or additional patterns suitable for measuring self and mutual capacitance of electrodes in the touch panel. For example, a pixelated electrode pattern can be configured to include a first row of electrodes being drive electrodes, a second row of electrodes being sense electrodes to form mutual capacitances with the first row electrodes, a third row of electrodes being sense electrodes to form mutual capacitances with the first row electrodes, a fourth row of electrodes similar to the second electrode row, and the pattern repeated for the remaining electrode rows. In another example, a pixelated electrode pattern can be configured as a first electrode being a drive electrode, adjacent electrodes surrounding the first electrode being sense electrodes to form mutual capacitances with the first electrode, a second group of adjacent electrodes surrounding the first group being sense electrodes to form mutual capacitances with the first electrode, a third group of adjacent electrodes being similar to the first adjacent group, and the pattern repeated for the remaining electrodes.

FIG. 20B illustrates another exemplary pixelated electrode pattern measuring self and mutual capacitance that can replace the pattern of FIG. 20A. In the example of FIG. 20B, touch panel 2000 can be configured to form a pixelated electrode pattern with electrode 2011a as a drive electrode, electrode 2011b as another drive electrode, electrode 2011c as a third drive electrode, electrode 2011d as a sense electrode, and the pattern repeated for the remaining electrodes. Here, while electrode 2011a is being driven to form the mutual capacitance Yee between it and sense electrode 2011d, the self capacitance Xe of electrode 2011a can be measured. At the same time, electrodes 2011b, 2011c can also be driven and their self capacitances Xe measured. Additional pixelated electrode patterns similar to those of FIGS. 15 and 17 can be formed, except the ground electrodes can be replaced with drive electrodes. For example, similar to FIG. 15, electrodes 1411a, 1411d can be driven and their self capacitances measured. Similar to FIG. 16, electrodes 1411b, 1411c can be driven and their self capacitances measured. Similar to FIG. 17, electrodes 1411a, 1411d can be driven and their self capacitances measured.

It should be understood that the pixelated electrode patterns are not limited to that illustrated in FIG. 20B, but can include other or additional patterns suitable for measuring self and mutual capacitance of electrodes in the touch panel. For example, a pixelated electrode pattern can be configured to include a first row of electrodes being drive electrodes, a second row of electrodes being drive electrodes, a third row of electrodes being sense electrodes to form mutual capacitances with the first row electrodes, a fourth row of electrodes being similar to the second row, and the pattern repeated for the remaining electrode rows. In another example, a pixelated electrode pattern can be configured to include a first electrode being a drive electrode, adjacent electrodes surrounding the first electrode being drive electrodes, a second group of adjacent electrodes surrounding the first adjacent group being sense electrodes to form mutual capacitances with the first electrode, a third group of adjacent electrodes surrounding the second group being similar to the first adjacent group, and the pattern repeated for the remaining electrodes.

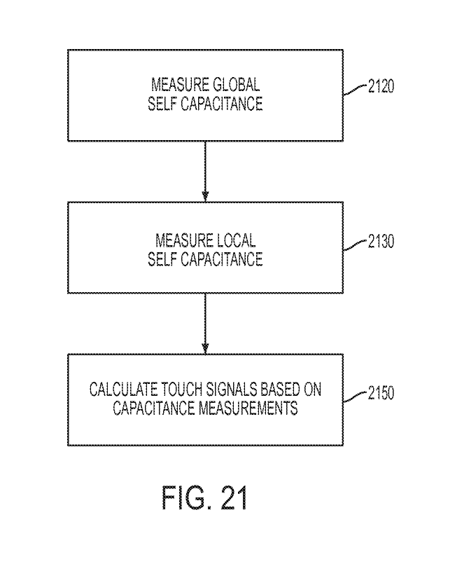

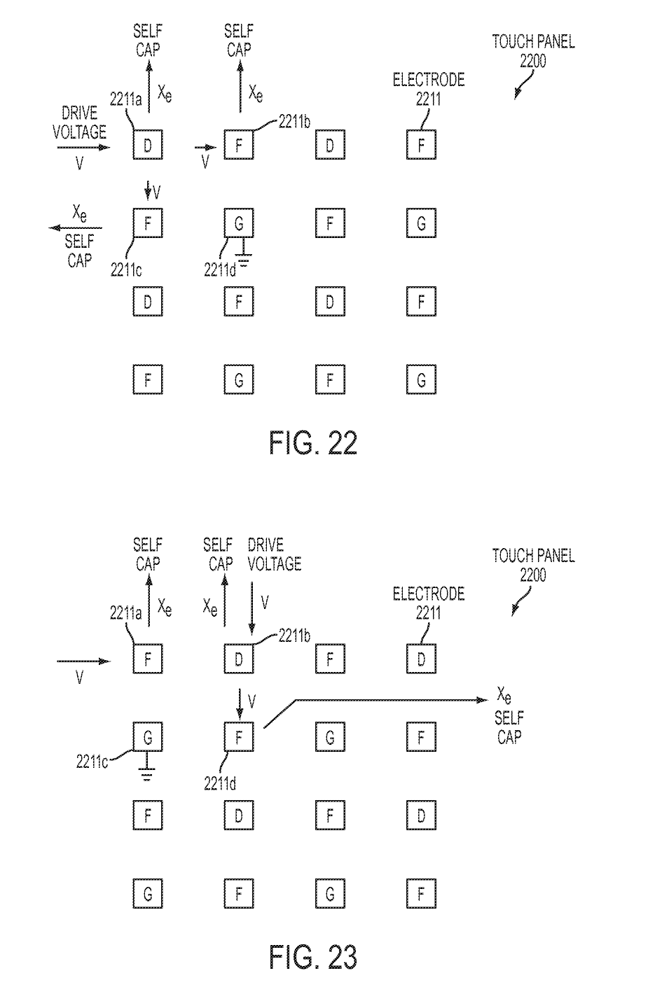

FIG. 21 illustrates still another exemplary method for user grounding correction of a touch signal in the pixelated electrode touch panel of FIG. 10. The FIG. 21 method is similar to the FIG. 11 method, but can replace the measuring of mutual capacitance with the measuring of local self capacitance. In the example of FIG. 21, a touch panel can capture self capacitances at various pixelated electrode patterns in the panel so as to measure the user's grounding condition and use the measurements to calculate touch signal corrected for any poor grounding conditions. Accordingly, the panel can measure global self capacitances Xe of the electrodes in the panel, as illustrated in FIG. 13, in a boot strap operation (2120). The panel can then measure local self capacitances Xe of the electrodes in the panel, in a non-boot strap operation (2130). FIGS. 22 through 25 illustrate exemplary pixelated electrode patterns measuring local self capacitances. In the example of FIG. 22, touch panel 2200 can be configured to form a pixelated electrode pattern with electrode 2211a as a drive electrode, horizontally adjacent electrode 2211b as a following electrode, vertically adjacent electrode 2211c as another following electrode, diagonal electrode 2211d as a ground electrode, and the pattern repeated for the remaining electrodes. The label “D” on certain electrodes 1411 can indicate the electrode is being driven, the label “G,” the electrode being grounded, and the label “F,” the electrode being driven, but its self capacitance not measured. The drive electrode 2211a can be driven by drive voltage V provided by drive circuitry (not shown), with the self capacitance Xe for that electrode being transmit to sense circuitry (not shown). The following electrodes 2211b, 2211c can also be driven by drive voltage V. By driving the following electrodes 2211b, 2211c, unwanted parasitic capacitances formed between the following electrodes and the adjacent drive electrode 2211a can be minimized, so as not to interfere with the self capacitance Xe from the drive electrode.

To ensure that local self capacitances are measured for all the electrodes, the panel can be configured to form a second pixelated electrode pattern by rotating the pattern of FIG. 22 clockwise 45 degrees. FIG. 23 illustrates the second pixelated electrode pattern. In the example of FIG. 23, touch panel 2200 can be configured to form a pixelated electrode pattern with electrode 2211a now as a following electrode, electrode 2211b as a drive electrode, electrode 2211c as a ground electrode, electrode 2211d as another following electrode, and the pattern repeated for the remaining electrodes. The self capacitance Xe of drive electrode 2211b can be measured.

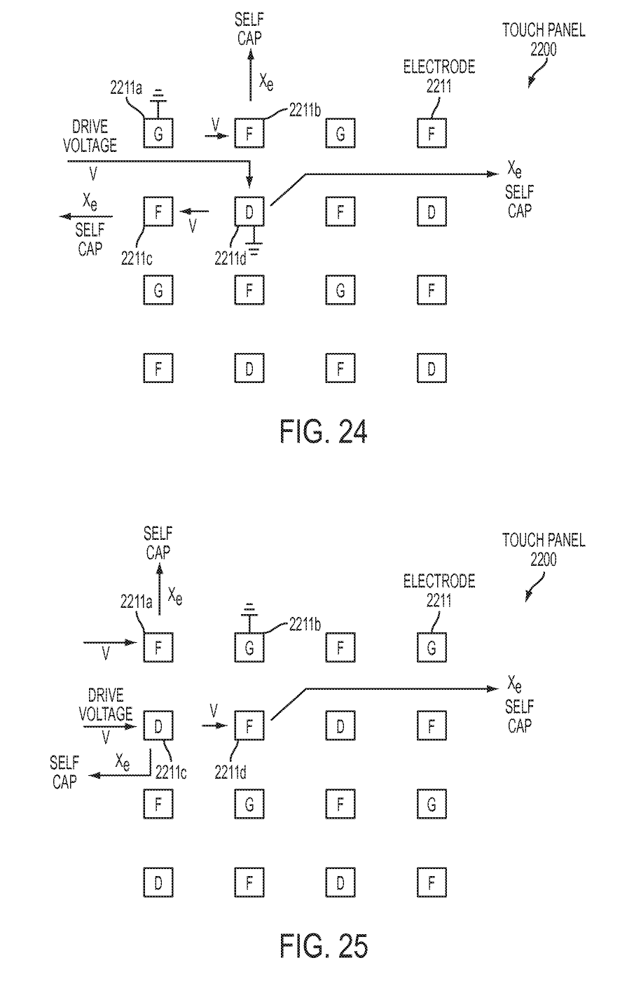

Generally, the patterns of FIGS. 22 and 23 can be sufficient to measure the local self capacitances. However, two more patterns as illustrated in FIGS. 24 and 25 can be used for additional measurements to average with the measurements obtained from the patterns of FIGS. 22 and 23. FIG. 24 illustrates a third pixelated electrode pattern formed by rotating the pattern of FIG. 23 clockwise 45 degrees. In the example of FIG. 24, touch panel 2200 can be configured to form a pixelated electrode pattern with electrode 2211a now as a ground electrode, electrode 2211b as a following electrode, electrode 2211c as another following electrode, electrode 2211d as a drive electrode, and the pattern repeated for the remaining electrodes. The self capacitance Xe of drive electrode 2211d can be measured.

FIG. 25 illustrates a fourth pixelated electrode pattern formed by rotating the pattern of FIG. 24 clockwise 45 degrees. In the example of FIG. 25, touch panel 2200 can be configured to form a pixelated electrode pattern with electrode 2211a now as a following electrode, electrode 2211b as a ground electrode, electrode 2211c as a drive electrode, electrode 2211d as another following electrode, and the pattern repeated for the remaining electrodes. The self capacitance Xe of drive electrode 2211c can be measured. Accordingly, the local self capacitances Xe can be measured in either two operations (FIGS. 22 and 23 patterns) or four operations (FIGS. 22 through 25 patterns).

It should be understood that the pixelated electrode patterns are not limited to those illustrated in FIGS. 22 through 25, but can include other or additional patterns suitable for measuring self capacitance of electrodes in the touch panel. For example, a pixelated electrode pattern can be configured with a first row of electrodes being drive electrodes, a second row of electrodes electrically following the drive electrodes, a third row of electrodes being ground electrodes, a fourth row of electrodes electrically following the drive electrodes, and the pattern repeated for the remaining electrode rows. In another example, a pixelated electrode pattern can be configured with a first electrode being a drive electrode, adjacent electrodes surrounding the first electrode being following electrodes, adjacent electrodes surrounding the following electrodes being ground electrodes, and the pattern repeated for the remaining electrodes.

Referring again to FIG. 21, after measuring the self capacitances, a user grounding correction factor can be determined based on the self capacitance measurements (2140) and used to calculate a touch signal corrected for user poor grounding conditions (2150). As described previously, Equation (2) can be used to correct for poor grounding conditions.

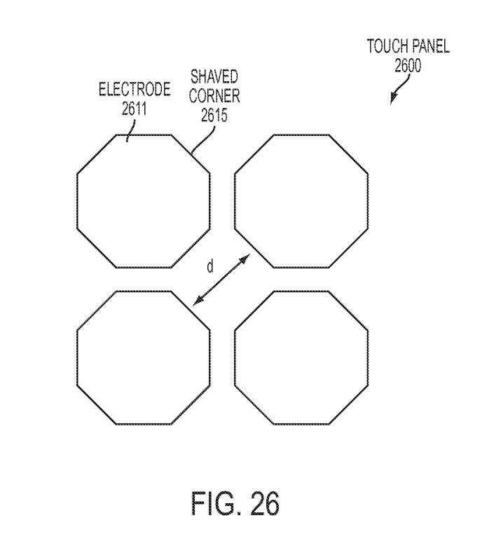

In addition to applying a user grounding correction factor to a touch signal, the structure of the touch electrodes can be designed so as to mitigate poor grounding conditions. FIG. 26 illustrates an exemplary pixelated electrode structure that can be used. In the example of FIG. 26, touch panel 2600 can include an array of touch electrodes 2611 shaped like octagons, with corners 2615 being shaved to form a distance d between diagonal electrodes, although other shapes can be used to provide the distance between diagonal electrodes. This structure can advantageously maximize self capacitance forming touch signals, while minimizing mutual capacitance between diagonal electrodes that can negatively affect touch signals, and electrode to ground capacitance that can negatively affect touch signals.

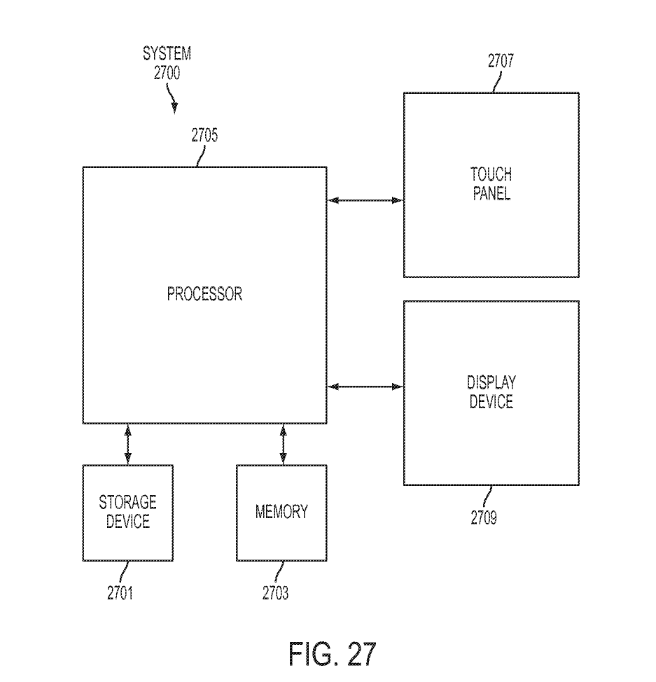

One or more of the touch panels can operate in a system similar or identical to system 2700 shown in FIG. 27. System 2700 can include instructions stored in a non-transitory computer readable storage medium, such as memory 2703 or storage device 2701, and executed by processor 2705. The instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The instructions can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

The system 2700 can also include display device 2709 coupled to the processor 2705. The display device 2709 can be used to display a graphical user interface. The system 2700 can further include touch panel 2707, such as in FIGS. 2 and 10, coupled to the processor 2705. Touch panel 2707 can have touch nodes capable of detecting an object touching or hovering over the panel at a location corresponding to a graphical user interface on the display device 2709. The processor 2705 can process the outputs from the touch panel 2707 to perform actions based on the touch or hover event and the displayed graphical user interface.

It is to be understood that the system is not limited to the components and configuration of FIG. 27, but can include other or additional components in multiple configurations according to various examples. Additionally, the components of system 2700 can be included within a single device, or can be distributed between multiple devices. In some examples, the processor 2705 can be located within the touch panel 2707 and/or the display device 2709.

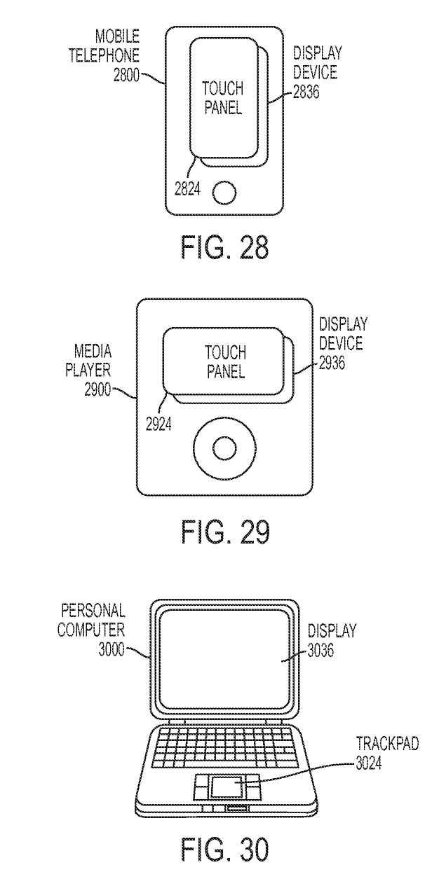

FIG. 28 illustrates an exemplary mobile telephone 2800 that can include touch panel 2824, display 2836, and other computing system blocks that can perform user grounding correction of touch signals in the touch panel according to various examples.

FIG. 29 illustrates an exemplary digital media player 2900 that can include touch panel 2924, display 2936, and other computing system blocks that can perform user grounding correction of touch signals in the touch panel according to various examples.

FIG. 30 illustrates an exemplary personal computer 3000 that can include touch panel (trackpad) 3024, display 3036, and other computing system blocks that can perform user grounding correction of touch signals in the touch panel according to various examples.

The mobile telephone, media player, and personal computer of FIGS. 28 through 30 can advantageously provide more accurate and faster touch signal detection, as well as power savings, and more robustly adapt to various grounding conditions of a user according to various examples.

Therefore, according to the above, some examples of the disclosure are directed to a touch panel comprising: an array of electrodes capable of sensing a touch; and multiple jumpers capable of selectively coupling groups of the electrodes together to form electrode rows and columns in zigzag patterns, at least some of the jumpers forming the rows and columns crossing each other. Alternatively or additionally to one or more of the examples disclosed above, in some examples the array of electrodes has a linear configuration. Alternatively or additionally to one or more of the examples disclosed above, in some examples each electrode has a solid surface and a square shape. Alternatively or additionally to one or more of the examples disclosed above, in some examples each electrode has an outer electrode and a center electrode, the outer and center electrodes being physically separate. Alternatively or additionally to one or more of the examples disclosed above, in some examples each electrode has a hollow center. Alternatively or additionally to one or more of the examples disclosed above, in some examples an electrode row comprises: a first jumper coupling a first electrode in a first row and first column of the array and a second electrode in a second row and second column of the array and diagonal to the first electrode, the first jumper coupling proximate corners of the first and second electrodes; and a second jumper coupling the second electrode to a third electrode in the first row and third column of the array and diagonal to the second electrode, the second jumper coupling proximate corners of the second and third electrodes, the first and second jumpers forming the electrode row in one of the zigzag patterns. Alternatively or additionally to one or more of the examples disclosed above, in some examples an electrode column comprises: a first jumper coupling a first electrode in a first row and second column of the array and a second electrode in a second row and first column of the array and diagonal to the first electrode, the first jumper coupling proximate corners of the first and second electrodes; and a second jumper coupling the second electrode to a third electrode in the third row and second column of the array and diagonal to the second electrode, the second jumper coupling proximate corners of the second and third electrodes, the first and second jumpers forming the electrode column in one of the zigzag patterns. Alternatively or additionally to one or more of the examples disclosed above, in some examples the zigzag patterns are capable of correcting user grounding conditions in the panel. Alternatively or additionally to one or more of the examples disclosed above, in some examples the panel is incorporated into at least one of a mobile telephone, a media player, or a portable computer.

Some examples of the disclosure are directed to a touch device comprising: a touch panel including: an array of electrodes capable of sensing mutual capacitance and self capacitance, and multiple jumpers capable of selectively coupling groups of the electrodes together to form electrode rows and columns in zigzag patterns; and a processor capable of receiving at least one of a set of mutual capacitance touch measurements or a set of self capacitance touch measurements taken from multiple sensing patterns of the electrodes, and determining a user grounding correction factor for the touch panel using the at least one set of measurements. Alternatively or additionally to one or more of the examples disclosed above, in some examples a first of the sensing patterns comprises the electrode rows and columns of the touch panel, the rows and columns being stimulated simultaneously to provide the set of self capacitance measurements, and a second of the sensing patterns comprises a pair of the electrode rows, one of the row pair being stimulated to drive the other of the row pair to transmit at least some of the set of mutual capacitance measurements, a third of the sensing patterns comprises a pair of the electrode columns, one of the column pair being stimulated to drive the other of the column pair to transmit at least others of the set of mutual capacitance measurements, and the processor receives the sets of mutual and self capacitance measurements from the first, second, and third sensing patterns. Alternatively or additionally to one or more of the examples disclosed above, in some examples a first of the sensing patterns comprises the electrode rows and columns of the touch panel, the rows and columns being stimulated simultaneously to provide the set of self capacitance measurements, a second of the sensing patterns comprises simultaneously a pair of the electrode rows, one of the row pair being stimulated to drive the other of the row pair to transmit at least some of the set of mutual capacitance measurements, and a pair of an electrode row and an electrode column, the row of the row-column pair being stimulated to drive the column of the row-column pair and the column of the row-column pair to transmit at least others of the set of mutual capacitance measurements, and the processor receives the sets of mutual and self capacitance measurements from the first and second sensing patterns.

Some examples of the disclosure are directed to a method for forming a touch panel, comprising: forming an array of electrodes for sensing a touch; forming multiple jumpers between the electrodes; selectively coupling first groups of the electrodes together with first groups of the jumpers to form electrode rows for driving the panel, the electrode rows forming a first zigzag pattern; selectively coupling second groups of the electrodes together with second groups of the jumpers to form electrode columns for transmitting a touch signal indicative of the touch, the electrode columns forming a second zigzag pattern; and crossing at least some of the first and second groups of jumpers. Alternatively or additionally to one or more of the examples disclosed above, in some examples selectively coupling first groups of the electrodes comprises coupling with the first groups of the jumpers adjacent diagonal corners of the first groups of electrodes together in a substantially horizontal direction to form the first zigzag pattern. Alternatively or additionally to one or more of the examples disclosed above, in some examples selectively coupling second groups of the electrodes comprises coupling with the second groups of the jumpers adjacent diagonal corners of the second groups of the electrodes together in a substantially vertical direction to form the second zigzag pattern.

Some examples of the disclosure are directed to a touch panel comprising: an array of electrodes capable of sensing a touch, each electrode having a non-solid surface; and multiple jumpers capable of selectively coupling groups of the electrodes together to form electrode rows and columns, at least some of the jumpers forming the rows and columns crossing each other. Alternatively or additionally to one or more of the examples disclosed above, in some examples the array of electrodes has a diamond configuration. Alternatively or additionally to one or more of the examples disclosed above, in some examples the non-solid surface comprises an outer electrode and a center electrode, the outer and center electrodes being physically separate. Alternatively or additionally to one or more of the examples disclosed above, in some examples the non-solid surface comprises a hollow center. Alternatively or additionally to one or more of the examples disclosed above, in some examples an electrode row comprises some of the jumpers coupling adjacent corners of a row of the electrodes. Alternatively or additionally to one or more of the examples disclosed above, in some examples an electrode column comprises some of the jumpers coupling adjacent corners of a column of the electrodes. Alternatively or additionally to one or more of the examples disclosed above, in some examples the non-solid surface is capable of mitigating noise at the panel. Alternatively or additionally to one or more of the examples disclosed above, in some examples the electrodes are capable of correcting user grounding conditions in the panel.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the appended claims.

What is claimed is:

1. A touch sensitive device comprising:
an array of touch node electrodes, each touch node electrode defining a unique (x, y) coordinate of the array of touch node electrodes, and each touch node electrode addressable by sense circuitry to measure a unique associated self-capacitance at each touch node electrode; and
a processor coupled to the array of touch node electrodes and configured to:
while measuring the unique associated self-capacitance at a first touch node electrode in the array of touch node electrodes:
apply a first voltage signal to a second touch node electrode in the array of touch node electrodes; and
apply a second voltage signal to a third touch node electrode in the array of touch node electrodes, the second voltage signal different from the first voltage signal.

2. The touch sensitive device of claim 1, wherein measuring the unique associated self-capacitance of the first touch node electrode comprises applying the first voltage signal to the first touch node electrode.

3. The touch sensitive device of claim 1, wherein the second touch node electrode is disposed adjacent to the first touch node electrode in the array of touch node electrodes.

4. The touch sensitive device of claim 1, wherein the third touch node electrode is disposed diagonal to the first touch node electrode in the array of touch node electrodes.

5. The touch sensitive device of claim 1, wherein the processor is further configured to, after measuring the unique associated self-capacitance at the first touch node electrode in the array of touch node electrodes:
measure the unique associated self-capacitance at the second touch node electrode in the array of touch node electrodes;
while measuring the unique associated self-capacitance at the second touch node electrode in the array of touch node electrodes:
apply the first voltage signal to one or more of the first touch node electrode or the third touch node electrode; and
apply the second voltage signal to a fourth touch node electrode in the array of touch node electrodes.

6. The touch sensitive device of claim 1, wherein the second voltage signal is a common voltage.

7. A method for determining touch signals at a touch sensitive device including an array of touch node electrodes, the method comprising:
addressing, with sense circuitry, a first touch node electrode included in the array of touch node electrodes;
measuring a unique associated self-capacitance of the first touch node electrode included in the array of touch node electrodes, wherein each touch node electrode defines a unique (x, y) coordinate of the array of touch node electrodes;
while measuring the unique associated self-capacitance at a first touch node electrode in the array of touch node electrodes:
applying a first voltage signal to a second touch node electrode in the array of touch node electrodes; and
applying a second voltage signal to a third touch node electrode in the array of touch node electrodes, the second voltage signal different from the first voltage signal.

8. The method of claim 7, wherein measuring the unique associated self-capacitance of the first touch node electrode comprises applying the first voltage signal to the first touch node electrode.

9. The method of claim 7, wherein the second touch node electrode is disposed adjacent to the first touch node electrode in the array of touch node electrodes.

10. The method of claim 7, wherein the third touch node electrode is disposed diagonal to the first touch node electrode in the array of touch node electrodes.

11. The method of claim 7, further comprising:
after measuring the unique associated self-capacitance at the first touch node electrode in the array of touch node electrodes:
measuring the unique associated self-capacitance at the second touch node electrode in the array of touch node electrodes;
while measuring the unique associated self-capacitance at the second touch node electrode in the array of touch node electrodes:
applying the first voltage signal to one or more of the first touch node electrode or the third touch node electrode; and
applying the second voltage signal to a fourth touch node electrode in the array of touch node electrodes.

12. The method of claim 7, wherein the second voltage signal is a common voltage.

13. A non-transitory computer-readable storage medium having stored thereon instructions for detecting touch signals at a touch sensitive device including an array of touch node electrodes, that when executed by a processor cause the processor to perform a method, the method comprising:
addressing, with sense circuitry, a first touch node electrode included in the array of touch node electrodes;
measuring a unique associated self-capacitance of the first touch node electrode included in the array of touch node electrodes, wherein each touch node electrode defines a unique (x, y) coordinate of the array of touch node electrodes;
while measuring the unique associated self-capacitance at a first touch node electrode in the array of touch node electrodes:
applying a first voltage signal to a second touch node electrode in the array of touch node electrodes; and
applying a second voltage signal to a third touch node electrode in the array of touch node electrodes, the second voltage signal different from the first voltage signal.

14. The non-transitory computer-readable storage medium of claim 13, wherein measuring the unique associated self-capacitance of the first touch node electrode comprises applying the first voltage signal to the first touch node electrode.

15. The non-transitory computer-readable storage medium of claim 13, wherein the second touch node electrode is disposed adjacent to the first touch node electrode in the array of touch node electrodes.

16. The non-transitory computer-readable storage medium of claim 13, wherein the third touch node electrode is disposed diagonal to the first touch node electrode in the array of touch node electrodes.

17. The non-transitory computer-readable storage medium of claim 13, wherein the method further comprises:
after measuring the unique associated self-capacitance at the first touch node electrode in the array of touch node electrodes:
measuring the unique associated self-capacitance at the second touch node electrode in the array of touch node electrodes;
while measuring the unique associated self-capacitance at the second touch node electrode in the array of touch node electrodes:
applying the first voltage signal to one or more of the first touch node electrode or the third touch node electrode; and
applying the second voltage signal to a fourth touch node electrode in the array of touch node electrodes.

18. The non-transitory computer-readable storage medium of claim 13, wherein the second voltage signal is a common voltage.
